(19) United States
(12) Patent Application Publication
(10) Pub. No.: US 2006/0189287 A1
(43) Pub. Date: Aug. 24, 2006

(54) Remote control system

(75) Inventors: Yeow Teng Toh, Singapore (SG); Kam Choon Kwong, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/563,927

(22) PCT Filed: Jun. 28, 2004
(86) PCT No.: PCT/IB04/51022

§ 371 Date: Jan. 9, 2006

(30) Foreign Application Priority Data
Jul. 11, 2003 (EP) 03102109.0

(51) Int. Cl. H04B 1/18; H04B 1/28

(52) U.S. Cl. 455/151.1; 455/333

(57) ABSTRACT

Transmitters (1) of remote control systems are provided with surfaceacoustic-wave-resonators (42) and receivers (2) are provided with variable inductors (54,79) for aligning the receiver, to optimise the performance versus the costs. A receiver oscillating-filtering circuit (24) comprises a single transistor (74), capacitors (76,77) and a variable inductor (79) to create a kind of “filtering” oscillator. A receiver ripple rejecting circuit (25) improves the operation of the receiver oscillating-filtering circuit 24 and of a receiver amplifying circuit (23) comprising a cascade design of two transistors (66,67). A receiver filtering circuit (26) between the receiver oscillatingfiltering circuit (24) and a receiver amplifying-shaping circuit (27) improves the operation of the latter. A transmitter oscillating-amplifying circuit (12) comprises a single power transistor (46) operating as a Colpitts oscillator. The remote control system avoids ceramic-resonators and chokes, and the receiver (2) avoids surfaceacoustic-wave-resonators. Power consumption is minimised.

The invention relates to a remote control system, to a receiver, to a transmitter, and to a method.

Examples of such remote control systems are car control systems, door control systems, consumer product control systems like wireless mouse systems, wireless keyboard systems, set top box systems, remote control systems for audio/video reproducers etc.

A prior art remote control system is known from WO 92/04779, which discloses in its FIG. 1 a receiver and in its FIG. 3 a transmitter. Both the receiver and the transmitter each comprise a ceramic resonator for establishing a frequency reference to realise increased frequency stability and receiver sensitivity.

The known remote control system is disadvantageous, inter alia, due to the remote control system with ceramic resonators being relatively costly.

It is an object of the invention, inter alia, of providing a relatively low cost remote control system.

Furthers objects of the invention are, inter alia, providing a receiver for a relatively low cost remote control system, a transmitter for a relatively low cost remote control system, and a method for use in combination with a relatively low cost remote control system.

The remote control system according to the invention comprises a transmitter and a receiver, which transmitter comprises—a transmitter oscillating—amplifying circuit comprising a surface-acoustic-wave-resonator; and—a transmitter antenna coupled to the transmitter oscillating-amplifying circuit; and which receiver comprises—a receiver antenna coupled to a receiver amplifying circuit and to a first inductor;—a receiver oscillating-filtering circuit coupled to the receiver amplifying circuit and comprising a second inductor; and—a receiver amplifying-shaping circuit coupled to the receiver oscillating-filtering circuit via a receiver filtering circuit; with at least one of these inductors being variable for aligning the receiver.

By providing the transmitter with a surface-acoustic-wave-resonator and by making the receiver alignable by introducing at least one variable inductor or coil at least either coupled to the receiver antenna or in the receiver oscillating-filtering circuit, ceramic resonators are avoided and the remote control system has become relatively low cost. Due to the presence of the surface-acoustic-wave-resonator in the transmitter, which surface-acoustic-wave-resonator is more accurate and a little more expensive than a variable inductor, in the receiver one or two variable inductors are sufficient to align the receiver with respect to the transmitter. Due to the transmitter usually being a hand-held device, the surface-acoustic-wave-resonator offers more stability to reduce the susceptibility to external effects resulting from a user's hand, moisture etc.

A first embodiment of the remote control system according to the invention is defined by claim 2. By providing the receiver oscillating-filtering circuit with a single transistor, the first capacitor, the second capacitor and the second inductor, a kind of “filtering” oscillator has been created. The single transistor operating as a common base amplifier is in fact a “weakened” oscillator with a filtering function, and is tuned by the first capacitor, the second capacitor and the second inductor. Instead of creating a prior art well defined oscillator at for example 433.92 Mhz with a 3 dB bandwidth of for example 0.1 MHz, the “weakened” oscillator according to the invention has a 3 dB bandwidth of for example 1 or 10 Mhz, and drifts up to for example 1 or 10 Mhz can now be handled.

A second embodiment of the remote control system according to the invention is defined by claim 3. By coupling the first inductor to a third capacitor in parallel and by coupling the second inductor to a fourth capacitor in parallel, both inductors form part of a LC circuit defined by a resonance frequency and a quality factor etc.

A third embodiment of the remote control system according to the invention is defined by claim 4. By coupling the second inductor to the receiver ripple rejecting circuit in the form of an active low-pass filter, ripple noise is rejected, which improves the operation of the receiver oscillating-filtering circuit and the receiver amplifying circuit. Compared to chokes, the receiver ripple rejecting circuit is less costly. The first reference terminal for example corresponds with ground, and the second reference terminal for example corresponds with a voltage supply terminal of a voltage supply which is further coupled to ground.

A fourth embodiment of the remote control system according to the invention is defined by claim 5. By providing the receiver amplifying circuit or low noise amplifier with the cascade design comprising the third and the fourth transistor, a total current consumption for the entire receiver below 1 mA has advantageously become possible (resulting in the receiver having a low power consumption), and expensive chokes are avoided.

A fifth embodiment of the remote control system according to the invention is defined by claim 6. The receiver filtering circuit or passive low-pass filter removes higher frequency components from the data coming from the receiver oscillating-filtering circuit for improving the operation of the receiver amplifying- shaping circuit.

A sixth embodiment of the remote control system according to the invention is defined by claim 7. By providing the receiver amplifying-shaping circuit or low noise amplifier and pulse shaper with the four transistors, a low cost receiver amplifying-shaping circuit has been created, and a total current consumption for the entire receiver below 1 mA has advantageously become possible (resulting in the receiver having a low power consumption).

A seventh embodiment of the remote control system according to the invention is defined by claim 8. By providing the transmitter oscillating-amplifying circuit with a single power transistor coupled to the surface-acoustic-wave-resonator and operating as a Colpitts oscillator, the transmitter is stable and still relatively low cost. The fourth inductor removes higher frequency components from the data coming from a transmitter data input, and the fifth inductor provides a “choking” effect without introducing an expensive choke. This transmitter comprises a low number of components and can be operated at low voltages like for example 1.2 Volt and does not consume power during the absence of data to be transmitted.

An eighth embodiment of the remote control system according to the invention is defined by claim 9. By making the remote control system ceramic-resonatorless and the receiver surface-acoustic-wave-resonatorless, the remote control system according to the invention is relatively low cost and relatively well performing

A ninth embodiment of the remote control system according to the invention is defined by claim 10. Printed antennas are used for shorter ranges like up to 10 or 15 meters, and non-printed antennas are used for longer ranges like 10 or 15 meters and more. A non-printed antenna for example comprises a physical wire or a helical antenna.

A tenth embodiment of the remote control system according to the invention is defined by claim 11. The transmitter is adapted to perform an amplitude shift keying modulation and the receiver is adapted to perform an amplitude shift keying demodulation, to keep the remote control system relatively low cost.

Embodiments of the transmitter according to the invention and of the receiver according to the invention and of the method according to the invention correspond with the corresponding embodiments of the remote control system according to the invention.

The invention is based upon an insight, inter alia, that ceramic resonators are to be avoided, and is based upon a basic idea, inter alia, that one or two variable inductors in the receiver and a surface-acoustic-wave-resonator in the transmitter are sufficient to realise a relatively low cost and relatively well performing remote control system.

The invention solves the problem, inter alia, of providing a relatively low cost remote control system, and is advantageous, inter alia, in that the remote control system according to the invention is relatively low cost and relatively well performing (optimised performance versus costs).

These and other aspects of the invention will be apparent from and elucidated with reference to the embodiments(s) described hereinafter.

### IN THE DRAWINGS

FIG. 1 shows in block diagram form a transmitter according to the invention;

FIG. 2 shows in block diagram form a receiver according to the invention;

FIG. 3 shows in block diagram form a transmitter input circuit of the transmitter according to the invention;

FIG. 4 shows in block diagram form a transmitter oscillating-amplifying circuit of the transmitter according to the invention;

FIG. 5 shows in block diagram form a receiver matching network of the receiver according to the invention;

FIG. 6 shows in block diagram form a receiver amplifying circuit of the receiver according to the invention;

FIG. 7 shows in block diagram form a receiver oscillating-filtering circuit of the receiver according to the invention;

FIG. 8 shows in block diagram form a receiver ripple rejecting circuit of the receiver according to the invention;

FIG. 9 shows in block diagram form a receiver filtering circuit of the receiver according to the invention; and

FIG. 10 shows in block diagram form a receiver amplifying-shaping circuit of the receiver according to the invention.

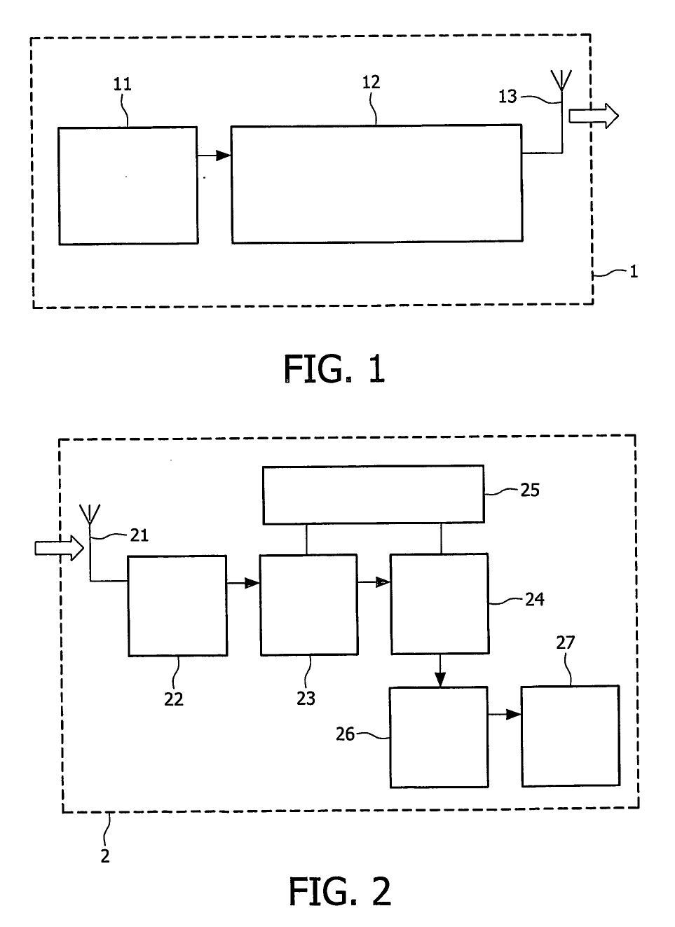

The transmitter 1 according to the invention shown in FIG. 1 comprises a transmitter input circuit 11 coupled to a transmitter oscillating-amplifying circuit 12 which is further coupled to a transmitter antenna 13.

The receiver 2 according to the invention shown in FIG. 2 comprises a receiver antenna 21 coupled to a receiver amplifying circuit 23 or low noise amplifier via a receiver matching network 22 and comprises a receiver oscillating-filtering circuit 24 coupled to the receiver amplifying circuit 23 and comprises a receiver amplifying-shaping circuit 27 coupled to the receiver oscillating-filtering circuit 24 via a receiver filtering circuit 26 and comprises a receiver ripple rejecting circuit 25 coupled to the receiver amplifying circuit 23 and to the receiver oscillating-filtering circuit 24.

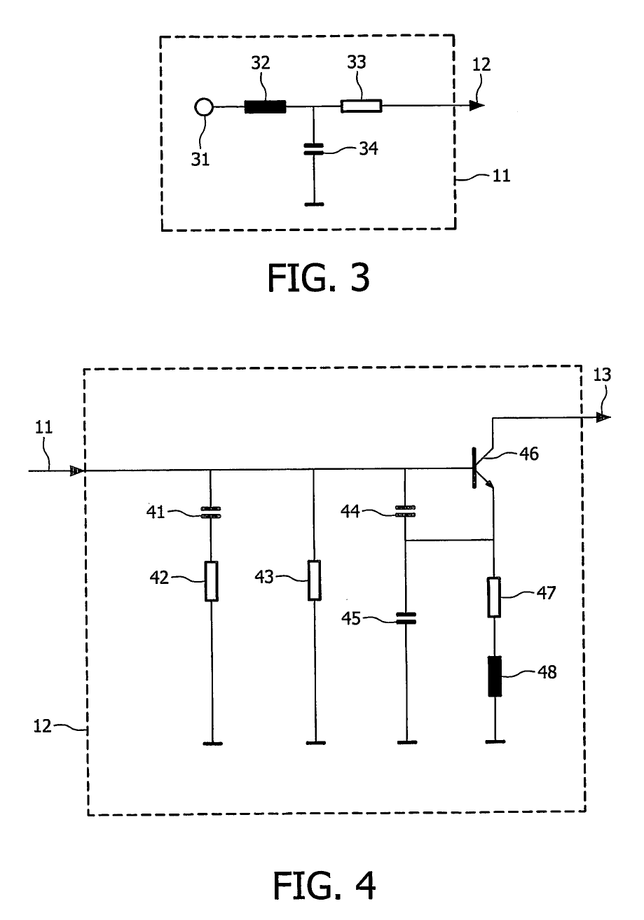

The transmitter input circuit 11 shown in FIG. 3 comprises a transmitter data input 31 for receiving data to be transmitted and coupled to a first reference terminal or ground via a serial circuit of an inductor 32 (coil) and a capacitor 34 and comprises a resistor 33 coupled to a common point of this serial circuit. The inductor 32 removes higher frequency components from the data coming from the transmitter data input. Inductor 32 for example has a value between 1 μH and 10 μH. Capacitor 34 for example has a value between 10 pF and 100 pF, and resistor 33 for example has a value between 10 kOhm and 100 kOhm.

The transmitter oscillating-amplifying circuit 12 shown in FIG. 4 comprises a single power transistor 46 (npn) of which transistor 46 a control electrode (basis) is coupled to a surface-acoustic-wave-resonator 42 via a capacitor 41 and to the transmitter input circuit 11 and of which transistor 46 a first main electrode (emitter) is coupled to the first reference terminal or ground via a serial circuit of a resistor 47 and an inductor 48 (coil) and of which transistor 46 a second main electrode (collector) is coupled to the transmitter antenna 13. The control electrode of transistor 46 is further coupled to ground via a resistor 43 and via a serial circuit of two capacitors 44,45, with a common point of this serial circuit being coupled to the first main electrode of transistor 46. Surface-acoustic-wave-resonator 42 is further coupled to ground. Transmitter antenna 13 is further coupled to a voltage source not shown and to ground via one or more capacitors not shown. By providing the transmitter oscillating-amplifying circuit 12 with a single power transistor 46 coupled to the surface-acoustic-wave-resonator 42 and operating as a Colpitts oscillator, the transmitter 1 is stable and still relatively low cost. The inductor 48 provides a “choking” effect without introducing an expensive choke. This transmitter 1 comprises a low number of components and can be operated at low voltages like for example 1.2 Volt and does not consume power during the absence of data to be transmitted. Inductor 48 for example has a value between 1 μH and 10 μH. Capacitors 44,45 each for example have a value between 1 pF and 10 pF, and capacitor 41 for example has a value between 10 pF and 100 pF. Resistor 47 for example has a value between 100 Ohm and 1 kOhm, and resistor 43 for example has a value between 10 kOhm and 100 kOhm.

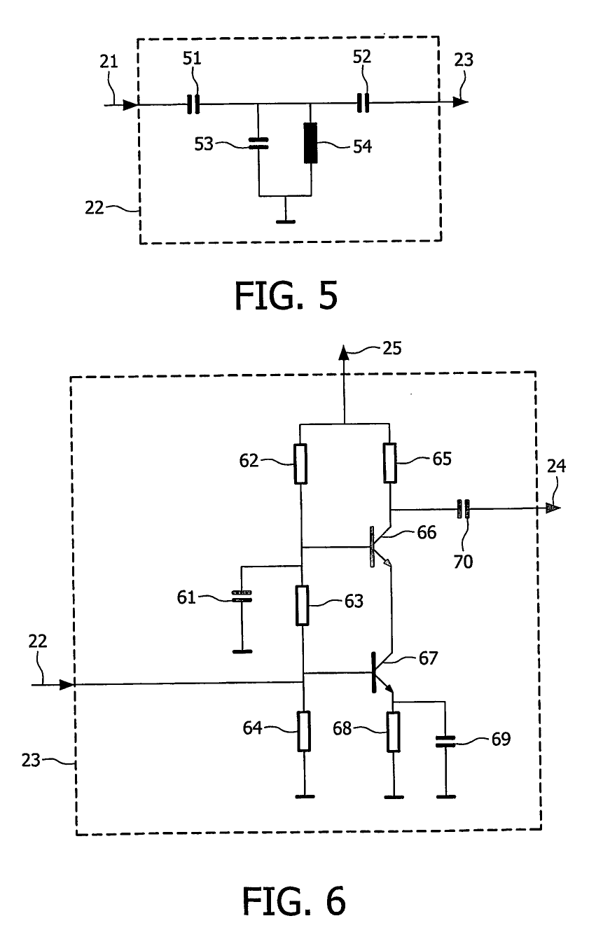

The receiver matching network 22 shown in FIG. 5 comprises a parallel circuit of a capacitor 53 and an inductor 54 (variable coil) coupled to ground and to a common point of a serial circuit of two capacitors 51,52 which are further coupled to the receiver antenna 21 and to the receiver amplifying circuit 23. Capacitors 51,52 for example each have a value between 0.1 pF and 2 pF, and capacitor 53 for example has a value between 1 pF and 10 pF. By varying inductor 54, the receiver 2 can be aligned with respect to the transmitter 1.

The receiver amplifying circuit 23 shown in FIG. 6 comprises two transistors 66,67 (npn) in cascade design, with a first main electrode (emitter) of the transistor 67 being coupled to the first reference terminal or ground via a parallel circuit of a resistor 68 and a capacitor 69, with a second main electrode (collector) of the transistor 67 being coupled to a first main electrode (emitter) of the transistor 66, with a second main electrode (collector) of the transistor 66 being coupled to the receiver ripple rejecting circuit 25 via a resistor 65 and to the receiver oscillating-filtering circuit 24 via a coupling capacitor 70, and with a control electrode (basis) of the transistor 67 being coupled to the receiver matching network 22. The control electrode of transistor 66 is coupled to the receiver ripple rejecting circuit 25 via a resistor 62 and to ground via a capacitor 61 and to a resistor 63 which is further coupled to the control electrode of the transistor 67 and to ground via a resistor 64 for biasing both transistors 66,67. By providing the receiver amplifying circuit 23 or low noise amplifier with the cascade design comprising the transistors 66,67, a total current consumption for the entire receiver 2 below 1 mA has advantageously become possible. This results in the receiver 2 having a low power consumption. Thereto, resistors 62,63,64 each for example have a value between 20 kOhm and 200 kOhm, and resistors 65,68 each for example have a value between 1 kOhm and 10 kOhm.

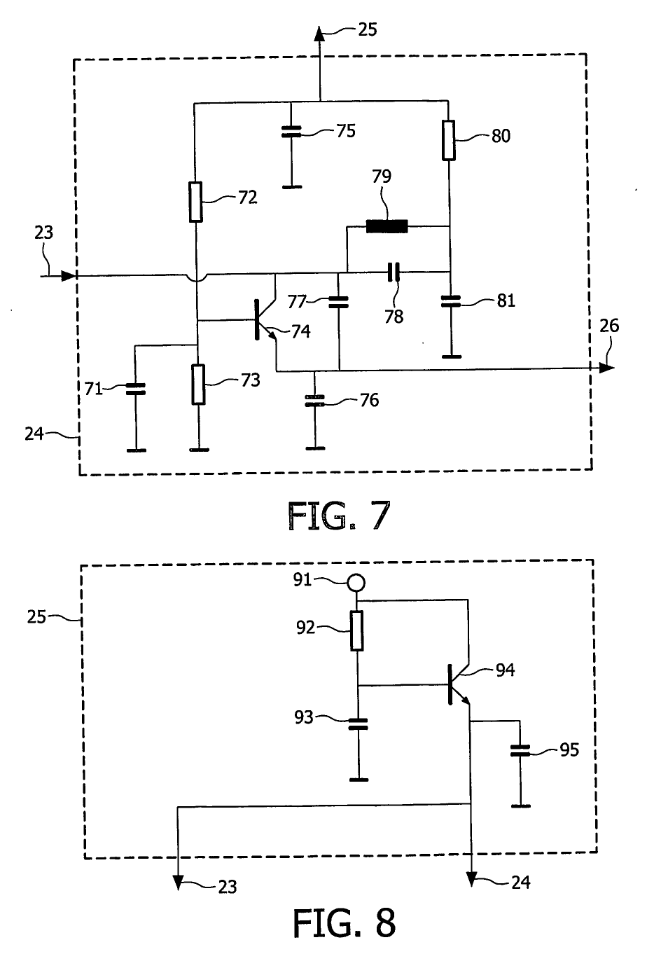

The receiver oscillating-filtering circuit 24 shown in FIG. 7 comprises a single transistor 74 (npn) of which transistor 74 a first main electrode (emitter) is coupled to the receiver filtering circuit 26 and to a capacitor 76 and to a side of a capacitor 77 and of which transistor 74 a second main electrode (collector) is coupled to the receiver amplifying circuit 23 and to an other side of the capacitor 77 and to a side of a parallel circuit of an inductor 79 (variable coil) and a capacitor 78. Another side of this parallel circuit is coupled to ground via a capacitor 81 and to the receiver ripple rejecting circuit 25 via a resistor 80. A control electrode (basis) of transistor 74 is coupled to ground via a resistor 73 and via a capacitor 71 and is coupled to the receiver ripple rejecting circuit 25 via a resistor 72 for biasing the transistor 74. The coupling to the receiver ripple rejecting circuit 25 is further coupled to ground via a capacitor 75 for filtering higher frequencies. By providing the receiver oscillating-filtering circuit 24 with a single transistor 74, the capacitors 76,77 and the inductor 79, a kind of “filtering” oscillator has been created. The single transistor 74 operating as a common base amplifier is in fact a “weakened” oscillator with a filtering function, and is tuned by the capacitors 76,77 and the inductor 79. Instead of creating a prior art well defined oscillator at for example 433.92 Mhz with a 3 dB bandwidth of for example 0.1 MHz, the “weakened” oscillator according to the invention has a 3 dB bandwidth of for example 1 or 10 Mhz, and drifts up to for example 1 or 10 Mhz can now be handled. Thereto, capacitors 76,77 each for example have a value between 1 pF and 10 pF. Resistors 72,73 each for example have a value between 20 kOhm and 200 kOhm, and resistor 80 for example has a value between 1 kOhm and 10 kOhm. Capacitor 78 for example has a value between 0.2 pF and 2 pF, and capacitor 81 for example has a value between 10 pF and 200 pF. By varying inductor 79, the receiver 2 can be aligned with respect to the transmitter 1.

The receiver ripple rejecting circuit 25 shown in FIG. 8 comprises a transistor 94 (npn) of which transistor 94 a first main electrode (emitter) is coupled to the receiver oscillating-filtering circuit 24 and to a first reference terminal or ground via a capacitor 95 and of which transistor 94 a second main electrode (collector) is coupled to a second reference terminal 91 and of which transistor 94 a control electrode (basis) is coupled to ground via a capacitor 93 and to the second reference terminal 91 via a resistor 92. The second reference terminal 91 for example corresponds with a voltage supply terminal of a voltage supply not shown which is further coupled to ground. By using the receiver ripple rejecting circuit 25 in the form of an active low-pass filter, ripple noise is rejected, which improves the operation of the receiver oscillating-filtering circuit 24 and the receiver amplifying circuit 23. Resistor 92 for example has a value between 10 kOhm and 100 kOhm, and capacitor 93 for example has a value between 2 nF and 20 nF and capacitor 95 for example has a value between 0.2 nF and 5 nF.

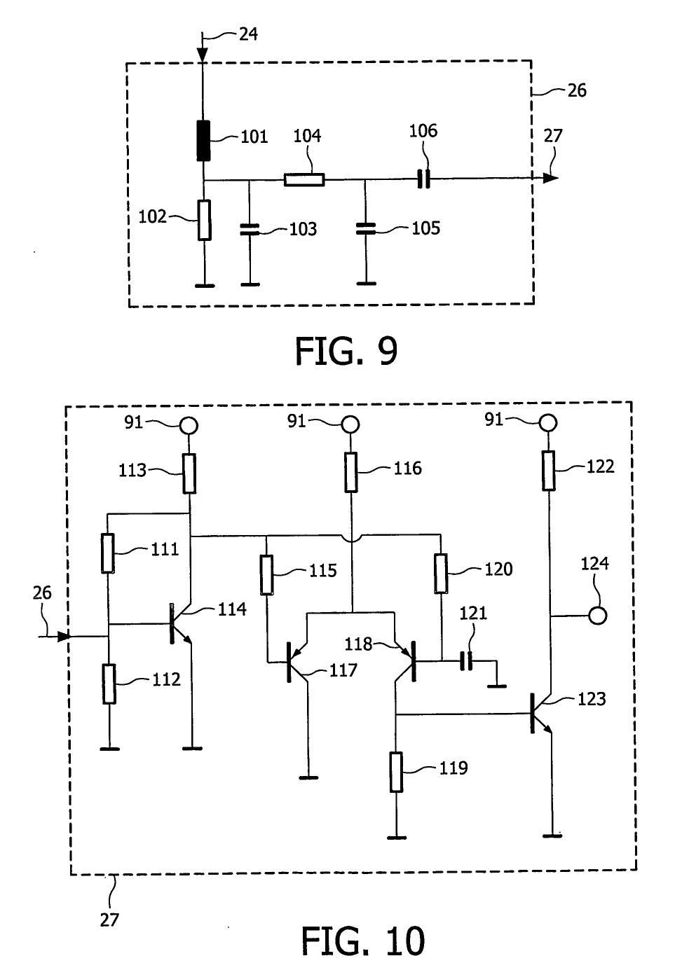

The receiver filtering circuit 26 shown in FIG. 9 comprises an inductor 101 (coil) coupled to the receiver oscillating-filtering circuit 24 and further coupled to ground via a parallel circuit of a resistor 102 and a capacitor 103 and to a side of a resistor 104 of which resistor 104 an other side is coupled to ground via a capacitor 105 and to the receiver amplifying-shaping circuit 27 via a capacitor 106. The receiver filtering circuit 26 or passive low-pass filter removes higher frequency components from the data coming from the receiver oscillating-filtering circuit 24 for improving the operation of the receiver amplifying-shaping circuit 27. Thereto, inductor 101 for example has a value between 100 nH and 1 μH, and capacitor 103 for example has a value between 10 pF and 100 pF, and resistor 102 for example has a value between 1 kOhm and 20 kOhm, and resistor 104 for example has a value between 10 kOhm and 100 kOhm, and capacitor 105 for example has a value between 0.1 nF and 5 nF.

The receiver amplifying-shaping circuit 27 shown in FIG. 10 comprises four transistors 114 (npn), 117 (pnp), 118 (pnp) and 123 (npn), with a control electrode (basis) of the transistor 114 being coupled to the receiver filtering circuit 26 and with a second main electrode (collector) of the transistor 114 being coupled to the second reference terminal 91 via a resistor 113 and to a control electrode (basis) of the transistor 117 via a resistor 115 and to a control electrode (basis) of the transistor 118 via a resistor 120, and with a second main electrode (collector) of the transistor 118 being coupled to a control electrode (basis) of the transistor 123 and to the first reference terminal or ground via a resistor 119, and with a second main electrode (collector) of the transistor 123 constituting a data output 124 of the receiver 2 and being coupled to the second reference terminal 91 via a resistor 122. The second main electrode of the transistor 114 is further coupled via a resistor 111 to the control electrode of the transistor 114, which control electrode is coupled to ground via a resistor 112 for biasing transistor 114. First main electrodes (emitters) of transistors 117,118 are coupled to each other and to the second reference terminal 91 via a resistor 116 for biasing both transistors 117,118, and a second main electrode (collector) of transistor 117 is coupled to ground. The control electrode of transistor 118 is further coupled to ground via a capacitor 121. By providing the receiver amplifying-shaping circuit 27 or low noise amplifier and pulse shaper with the four transistors 114,117,118,123, a low cost receiver amplifying-shaping circuit 27 has been created, and a total current consumption for the entire receiver 2 below 1 mA has advantageously become possible (resulting in the receiver 2 having a low power consumption). Thereto, resistors 111,112 each for example have a value between 1 Mohm and 10 Mohm, and resistors 113,115,116,119,120 and 122 each for example have a value between 10 kOhm and 200 kOhm.

The remote control system is ceramic-resonatorless and the receiver 2 is surface-acoustic-wave-resonatorless, resulting in the remote control system according to the invention being relatively low cost and relatively well performing. Printed antennas are used for shorter ranges like up to 10 or 15 meters, and non-printed antennas are used for longer ranges like 10 or 15 meters and more. The transmitter 1 is adapted to perform an amplitude shift keying modulation and the receiver 2 is adapted to perform an amplitude shift keying demodulation, to keep the remote control system relatively low cost.

The expression “for” in for example “for A” and “for B” does not exclude that other functions “for C” are performed as well, simultaneously or not. The expressions “X coupled to Y” and “a coupling between X and Y” and “coupling/couples X and Y” etc. do not exclude that an element Z is in between X and Y. The expressions “P comprises Q” and “P comprising Q” etc. do not exclude that an element R is comprised/included as well. Other transistors and turned main electrodes can be used without departing from the scope of this invention.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

The invention is based upon an insight, inter alia, that ceramic resonators are to be avoided, and is based upon a basic idea, inter alia, that one or two variable inductors in the receiver and a surface-acoustic-wave-resonator in the transmitter are sufficient to realise a relatively low cost and relatively well performing remote control system.

The invention solves the problem, inter alia, of providing a relatively low cost remote control system, and is advantageous, inter alia, in that the remote control system according to the invention is relatively low cost and relatively well performing (optimised performance versus costs).

1. A remote control system comprising a transmitter (1) and a receiver (2), which transmitter (1) comprises—a transmitter oscillating-amplifying circuit (12) comprising a surface-acoustic-wave-resonator (42); and—a transmitter antenna (13) coupled to the transmitter oscillating-amplifying circuit (12); and which receiver (2) comprises—a receiver antenna (21) coupled to a receiver amplifying circuit (23) and to a first inductor (54);—a receiver oscillating-filtering circuit (24) coupled to the receiver amplifying circuit (23) and comprising a second inductor (79); and—a receiver amplifying-shaping circuit (27) coupled to the receiver oscillating-filtering circuit (24) via a receiver filtering circuit (26); with at least one of these inductors (54,79) being variable for aligning the receiver (2).

2. A remote control system as defined in claim 1, wherein the receiver oscillating-filtering circuit (24) comprises a first transistor (74) of which first transistor (74) a first main electrode is coupled to the receiver filtering circuit (26) and to a first capacitor (76) and to a side of a second capacitor (77) and of which first transistor (74) a second main electrode is coupled to the receiver amplifying circuit (23) and to an other side of the second capacitor (77) and to the second inductor (79).

3. A remote control system as defined in claim 2, wherein the first inductor (54) is coupled to a third capacitor (53) in parallel and the second inductor (79) is coupled to a fourth capacitor (78) in parallel.

4. A remote control system as defined in claim 3, wherein the second inductor (79) is further coupled to a receiver ripple rejecting circuit (25) comprising a second transistor (94) of which second transistor (94) a first main electrode is coupled to the second inductor (79) via a first resistor (80) and to a first reference terminal via a fifth capacitor (95) and of which second transistor (94) a second main electrode is coupled to a second reference terminal (91) and of which second transistor (94) a control electrode is coupled to a sixth capacitor (93) and to the second reference terminal (91) via a second resistor (92).

5. A remote control system as defined in claim 4, wherein the receiver amplifying circuit (23) comprises a third (67) and a fourth (66) transistor, with a first main electrode of the third transistor (67) being coupled to the first reference terminal via a parallel circuit of a third resistor (68) and a seventh capacitor (69), with a second main electrode of the third transistor (67) being coupled to a first main electrode of the fourth transistor (66), with a second main electrode of the fourth transistor (66) being coupled to the first main electrode of the second transistor (94) via a fourth resistor (65) and to the second main electrode of the first transistor (74), and with a control electrode of the third transistor (67) being coupled to the receiver antenna (21) and to the first inductor (54).

6. A remote control system as defined in claim 5, wherein the receiver filtering circuit (26) comprises a third inductor (101) coupled to the first main electrode of the first transistor (74) and further coupled to a parallel circuit of fifth resistor (102) and an eighth capacitor (103) and to a nineth capacitor (105) via a sixth resistor (104), which parallel circuit and which nineth capacitor (105) are further coupled to the first reference terminal.

7. A remote control system as defined in claim 6, wherein the receiver amplifying-shaping circuit (27) comprises a fifth (114), sixth (117), seventh (118) and eighth (123) transistor, with a control electrode of the fifth transistor (114) being coupled to the nineth capacitor (105) and with a second main electrode of the fifth transistor (114) being coupled to the second reference terminal (91) via a seventh resistor (113) and to a control electrode of the sixth transistor (117) via an eighth resistor (115) and to a control electrode of the seventh transistor (118) via a nineth resistor (120), and with a second main electrode of the seventh transistor (118) being coupled to a control electrode of the eighth transistor (123) and to the first reference terminal via a tenth resistor (119), and with a second main electrode of the eighth transistor (123) constituting a data output (124) of the receiver (2) and being coupled to the second reference terminal (91) via an eleventh resistor (122).

8. A remote control system as defined in claim 7, wherein the transmitter oscillating-amplifying circuit (12) comprises a ninth transistor (46) of which ninth transistor (46) a control electrode is coupled to the surface-acoustic-wave-resonator (42) via a tenth capacitor (41) and to a transmitter input circuit (11) comprising a fourth inductor (32) and of which ninth transistor (46) a first main electrode is coupled to the first reference terminal via a serial circuit of a twelfth resistor (47) and a fifth inductor (48) and of which ninth transistor (46) a second main electrode is coupled to the transmitter antenna (13).

9. A remote control system as defined in claim 1, wherein the remote control system is ceramic-resonatorless, with the receiver (2) being surface-acoustic-wave-resonatorless.

10. A remote control system as defined in claim 1, wherein each antenna (13,21) comprises a printed antenna for shorter ranges and/or a non-printed antenna for longer ranges.

11. A remote control system as defined in claim 1, wherein the transmitter (1) is adapted to perform an amplitude shift keying modulation and the receiver (2) is adapted to perform an amplitude shift keying demodulation.

12. A transmitter (1) for use in a remote control system comprising the transmitter (1) and a receiver (2), which transmitter comprises—a transmitter oscillating-amplifying circuit (12) comprising a surface-acoustic-wave-resonator (42); and—a transmitter antenna (13) coupled to the transmitter oscillating-amplifying circuit (12).

13. A receiver (2) for use in a remote control system comprising a transmitter (1) and the receiver (2), which receiver (1) comprises—a receiver antenna (21) coupled to a receiver amplifying circuit (23) and to a first inductor (54);—a receiver oscillating-filtering circuit (24) coupled to the receiver amplifying circuit (23) and comprising a second inductor (79); and—a receiver amplifying-shaping circuit (27) coupled to the receiver oscillating-filtering circuit (24) via a receiver filtering circuit (26);—with at least one of these inductors (54,79) being variable for aligning the receiver (2).

14. A method for use in combination with a remote control system comprising a transmitter (1) and a receiver (2), which transmitter (1) comprises—a transmitter oscillating-amplifying circuit (12) comprising a surface-acoustic-wave-resonator (42); and—a transmitter antenna (13) coupled to the transmitter oscillating-amplifying circuit (12); and which receiver (2) comprises—a receiver antenna (21) coupled to a receiver amplifying circuit (23) and to a first inductor (54);—a receiver oscillating-filtering circuit (24) coupled to the receiver amplifying circuit (23) and comprising a second inductor (79); and—a receiver amplifying-shaping circuit (27) coupled to the receiver oscillating-filtering circuit (24) via a receiver filtering circuit (26); with at least one of these inductors (54,79) being variable, and which method comprises the step of aligning the receiver (2) through varying at least one of these inductors (54,79).
